(19) United States
(12) Patent Application Publication
(10) Pub. No.: US 2025/0096428 A1
(43) Pub. Date: Mar. 20, 2025

(54) BATTERY

(71) Applicant: MAHLE International GmbH, Stuttgart (DE)

(72) Inventor: Johannes Weinmann, Stuttgart (DE)

(21) Appl. No.: 18/890,747

(22) Filed: Sep. 19, 2024

(30) Foreign Application Priority Data
Sep. 20, 2023 (DE) 10 2023 209 130.5

(51) Int. Cl. H01M 50/514; H01M 50/249; H01M 50/291

(52) U.S. Cl. CPC H01M 50/514; H01M 50/249; H01M 50/291

(57) ABSTRACT

A battery for a vehicle is disclosed. The battery includes a housing, first and second cell units with at least two battery cells. The first cell unit has a plug and the second cell unit has a socket. A plug connection is insertable into a socket opening. The socket has an insertion chamfer along the direction of installation and the plug has a plug contour complementary to the insertion chamfer, such that when the first and second cell units are moved relative to one another in the direction of installation. The insertion chamfer interacts with the plug contour to center the at least one plug connection relative to the associated socket opening.

### CROSS-REFERENCE TO RELATED APPLICATION

This application claims priority to German Application No. DE 10 2023 209 130.5 filed on Sep. 20, 2023, the contents of which are hereby incorporated by reference in its entirety.

### TECHNICAL FIELD

The present invention relates to a battery, in particular a traction battery for a vehicle, which has a housing with cell units arranged in the housing. The invention also relates to a vehicle with such a battery.

### BACKGROUND

A battery usually comprises several battery cells for storing and supplying electrical energy. The battery cells are usually electrically connected to each other within the battery. A group of battery cells can be combined to form a unit, which is also referred to below as a cell unit. A battery can comprise two or more such cell units, which are electrically connected to each other.

Such cell units are accommodated in a battery casing. The electrical connection between the cell units can be realized by electrically connecting busbars protruding from adjacent cell units, usually by means of screws. This requires access to the conductor rails. The housing usually has a corresponding opening for this purpose. This opening must be sealed again after the battery has been installed and, in particular, after the electrical connection between the conductor rails has been established. This leads to increased installation and manufacturing costs.

The present invention deals with the task of providing improved or at least other embodiments for a battery of the type mentioned at the beginning and for a vehicle with such a battery.

The invention solves this problem by the scope of the independent claim(s). Advantageous embodiments are the scope of the dependent claims.

### SUMMARY

Accordingly, the present invention is based on the basic idea of electrically connecting cell units accommodated in a housing of a battery to one another via a plug and a socket which are designed to complement one another, so that the plug and the socket lead to automatic centering of the plug to the socket when the cell units are pushed together. The use of the plug and socket eliminates the need for separate access in the housing, in particular openings in the housing, for the purpose of electrically connecting the cell units to each other. This results in simplified installation and production of the battery. In addition, reductions in the mechanical stability of the housing caused by such accesses, in particular reductions in the rigidity of the housing, are avoided. This results in improved crash properties of the battery.

In accordance with the idea of the invention, the battery has two cell units arranged in the housing. The cell units follow each other in one direction, which is also referred to below as the direction of installation. The successive cell units in the direction of installation are also referred to below as the first cell unit and the second cell unit. The respective cell unit comprises at least two, preferably several, battery cells, which are electrically connected to each other in the cell unit. On its side facing the second cell unit along the direction of installation, the first cell unit has a plug with at least one plug connection projecting along the direction of installation. The second cell unit has a socket on its side facing along the direction of installation of the first cell unit, which has an associated socket opening for the respective plug connection. The respective plug connection is plugged into the corresponding socket opening so that the cell units are electrically connected to each other. The socket has an insertion chamfer along the direction of installation and the plug has a plug contour complementary to the insertion chamfer in such a way that when the cell units are moved in the direction of installation relative to one another, in particular when the cell units are pushed together in the housing during battery installation, the insertion chamfer interacts with the plug contour in order to center the respective plug connection to the associated socket opening.

The insertion chamfer runs at an angle to the direction of installation.

The plug contour is at an appropriate angle to the direction of installation.

The angle of the insertion chamfer and plug contour as well as their position is such that the respective plug connection is centered in relation to the corresponding socket opening.

It is understood that the battery can also have three or more consecutive cell units along the direction of installation. Successive cell units can be electrically connected to each other along the direction of the stacking disk as described for the first cell unit and second cell unit. This means that successive cell units along the direction of the stacking disk can have plugs and sockets facing each other. It is therefore particularly conceivable that at least one cell unit has such a plug and such a socket on opposite sides along the direction of installation. For ease of understanding, the following description refers to two cell units, wherein it is understood that the description can be transferred to the above-described constellation with three or more consecutive cell units in the direction of installation.

The battery can be used in any application.

Advantageously, the battery is a traction battery, i.e., one that supplies electrical energy for propulsion and can be recharged as required.

The battery, in particular the traction battery, is used in a vehicle, for example. In particular, the vehicle is therefore a battery electric vehicle.

The socket advantageously has a base, which preferably runs transverse to the direction of installation. The base is also referred to below as the socket base. The base of the socket has at least one socket opening. A socket edge of the socket, which has the insertion chamfer, protrudes from the socket base. This means that the insertion chamfer is formed at the socket edge. The socket edge therefore has the insertion chamfer or forms the insertion chamfer. This results in reliable centering and consequently simplified installation and production of the battery.

In advantageous embodiments, the plug has a base from which the at least one plug connection protrudes. The base is also referred to below as the plug base. The plug also has a plug edge protruding from the plug base, on which the plug contour is formed. The plug edge therefore has the plug contour or forms the plug contour. This leads to reliable centering and therefore simplified installation and production of the battery.

It is conceivable that the plug is arranged in the socket when plugged in. In particular, this means that the insertion chamfer surrounds the plug contour when plugged in.

In advantageous embodiments, the plug contour surrounds the insertion chamfer when plugged in. This means that the insertion chamfer is arranged in the plug contour when plugged in, i.e., the plug contour surrounds the insertion chamfer. The plug can be made larger in this way. This means that the plug with at least one protruding plug connection is more stable against mechanical influences when the cell units are pushed together. This in turn leads to simplified production and reduced damage.

Preferably, at least one of the cell units has a frame surrounding the associated battery cells, preferably in the form of a housing.

In advantageous embodiments, the first cell unit has such a frame, wherein the frame forms the plug contour, preferably the plug edge. In particular, this means that the plug contour is molded onto the frame. Preferably, the frame also forms the plug base. This simplifies production and increases the mechanical stability of the plug.

In advantageous embodiments, the second cell unit has such a frame, wherein the frame forms the insertion chamfer, preferably the socket edge. In particular, this means that the insertion chamfer is formed on the frame. The frame also preferably forms the socket base. This simplifies production and increases the mechanical stability of the socket.

The battery advantageously has an end stop for the plug and socket. This means that the end stop blocks any further movement of the cell units when they are plugged in. This prevents or at least reduces damage to the plug and/or socket.

Advantageously, the end stop is formed on at least one of the cell units.

Preferably, the end stop has a stop surface on the respective cell unit, wherein the stop surfaces abut against the socket when the plug is plugged in.

In principle, the housing can be manufactured in any way.

Advantageously, the housing has an extruded profile that is open in the direction of installation, in which the cell units are arranged. This results in a simplified, cost-effective and precise production of the housing. In addition, openings in the extruded profile for the electrical connection of the cell units are avoided due to the plug and socket. In addition to the simplified, cost-effective production, this results in increased mechanical stability, in particular increased rigidity of the housing.

The open sides of the extruded profile can be closed by means of at least one cover. In this case, the housing therefore has at least one cover which closes the extruded profile, wherein the cover is conveniently attached to the extruded profile after the cell unit has been pushed together in the extruded profile.

It is understood that in addition to the battery, a vehicle with the battery is also included in the scope of the present invention.

Further important features and advantages of the invention are apparent from the sub-claims, from the drawings and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

The following is shown in the figures, in each case schematically:

FIG. 1 a simplified section through a battery with cell units, a plug and a socket,

FIG. 2 an isometric view of the battery plug,

FIG. 3 an isometric view of the battery socket,

FIG. 4 an isometric sectional view of the plug and the socket when plugged in,

FIG. 5 a highly simplified view of the battery in the area of the cell units,

FIG. 6 a highly simplified view of the battery in a vehicle

### DETAILED DESCRIPTION

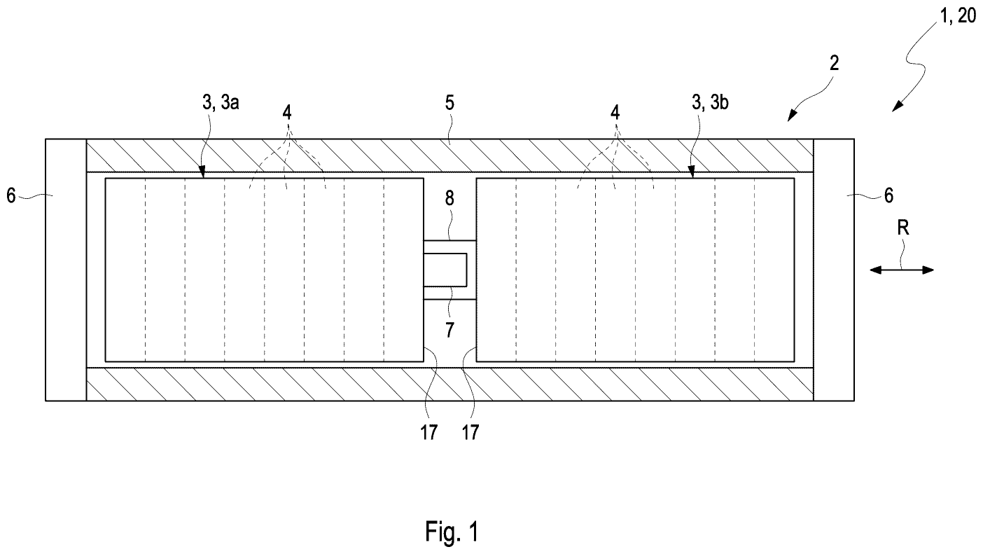

A battery 1, as shown as an example in the figures, has a housing 2 shown only in FIG. 1. As can be seen in particular in FIG. 1, at least two cell units 3 are accommodated in the housing 2. The respective cell unit 3 has battery cells 4, indicated by the dashed lines in FIG. 1, which are electrically connected to each other in the cell unit 3. The battery cells 4 can be prismatic cells or pouch cells, for example. In the exemplary embodiments shown, two cell units 3 can be seen purely by way of example, namely a first cell unit 3, 3a and a second cell unit 3, 3b, which follow one another in a direction R. The direction R is also referred to below as the direction of installation R. As shown in FIG. 1, the housing 2 can have an extruded profile 5 which is open on both sides along the direction of installation R and in which the cell units 3 are arranged. The open sides of the extruded profile 5 are closed by covers 6 of the housing 2. To install the battery 1, the cell units 3 are pushed into the housing 2 in the direction of installation R, in the exemplary embodiments shown into the extruded profile 5. The cell units 3 are moved towards each other in the direction of installation R, i.e., pushed together in the direction of installation R.

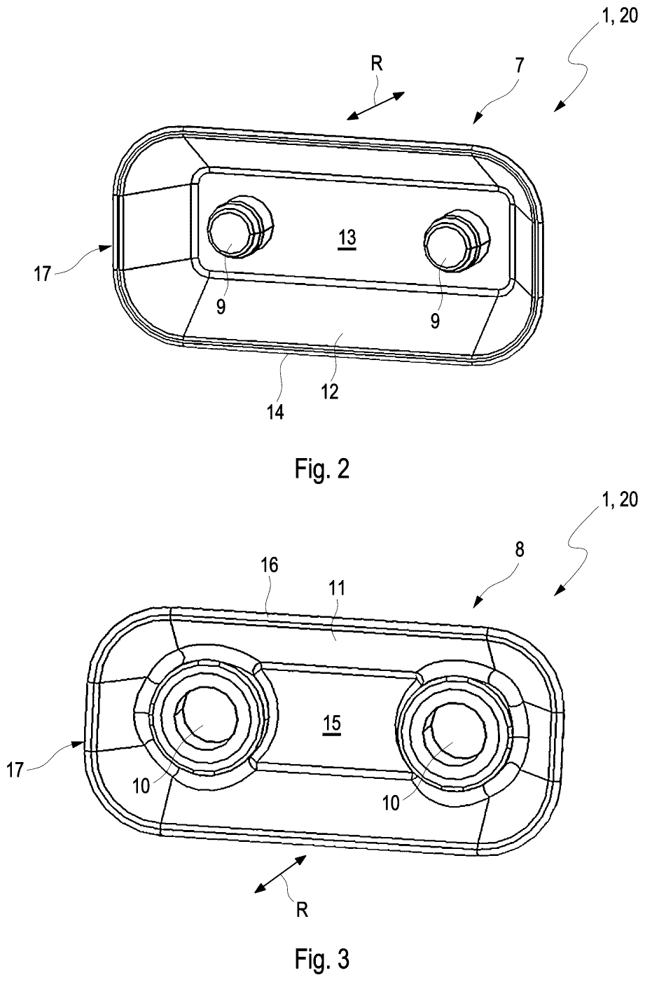

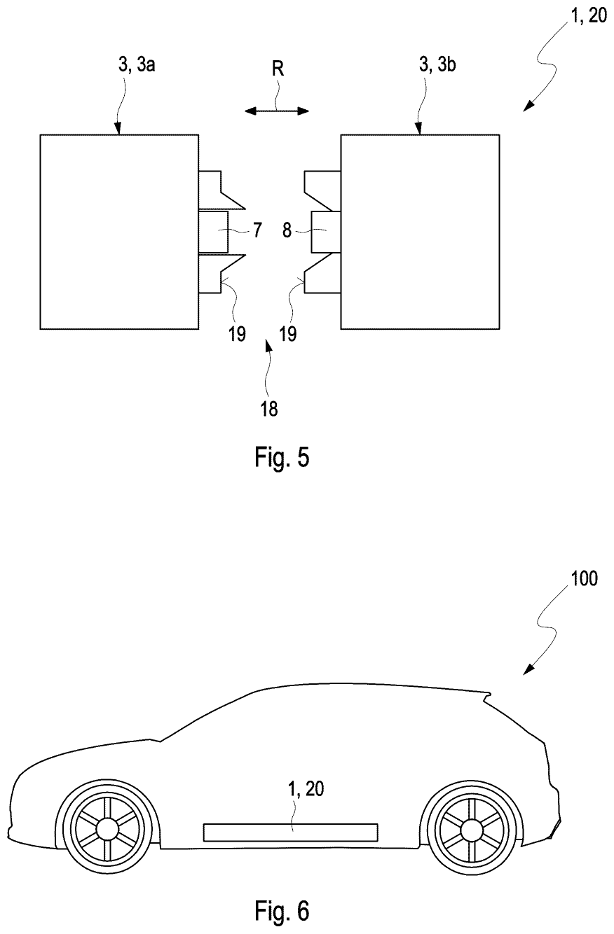

As can be seen from FIGS. 1 through 5, the cell units 3 have a plug 7 or a socket 8 on the sides facing each other in the direction of installation R. This means that the first cell unit 3, 3a has a plug 7 on its side facing the second cell unit 3, 3b along the direction of installation R and the second cell unit 3, 3b has a socket 8 on its side facing the first cell unit 3, 3a along the direction of installation R. In the illustrations in FIGS. 1 and 5, the first cell unit 3, 3a is shown on the left and the second cell unit 3, 3b on the right by way of example only. The plug 7 has at least one plug connection 9 projecting along the direction of installation R and the socket 8 has an associated opening 10 for the respective plug connection 9, which is also referred to below as socket opening 10. When the battery 1 is installed, the respective plug connection 9 is plugged into the corresponding socket opening 10 in order to electrically connect the cell units 3 to each other. As can be seen from FIGS. 2 through 4, the plug 7 in the exemplary embodiments shown has two plug connections 9 and the socket 8 correspondingly has two socket openings 10. In the exemplary embodiments shown, the plug connections 9 are purely cylindrical in shape.

As can be seen from FIGS. 2 through 4, the socket 8 has an insertion chamfer 11 along the direction of installation R and the plug 7 has a contour 12 complementary to the insertion chamfer 11, which is also referred to below as plug contour 12. The insertion chamfer 11 and the plug contour 12 are designed in such a way that when the cell units 3 are moved in the direction of installation R relative to one another, i.e., when the cell unit 3 is pushed together in the direction of installation R in the housing 2, the insertion chamfer 11 interacts with the plug contour 12 in order to center the respective plug connection 9 relative to the associated socket opening 10.

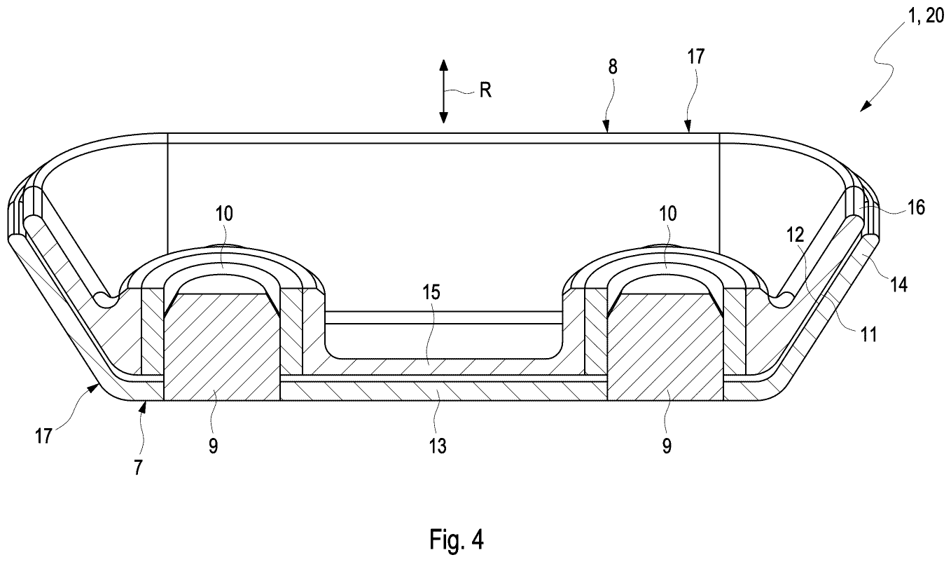

As can be seen from FIGS. 2 and 4, the plug 7 in the exemplary embodiments shown has a base 13 from which the at least one plug connection 9 protrudes outwards. The base 13 is also referred to below as the plug base 13. In addition, the plug 7 has an edge 14 protruding from the plug base 13, which is also referred to below as plug edge 14. The plug contour 12 is formed on the plug edge 14. For this purpose, the plug edge 14 extends at an angle to the direction of installation R. According to FIGS. 3 and 4, the socket 8 in the exemplary embodiments shown has a base 15 with at least one socket opening 10. The base 15 is also referred to below as socket base 15. In addition, the socket 8 has an edge 16 protruding from the socket base 15, which is also referred to below as the socket edge 16. The insertion chamfer 11 is formed at the socket edge 16. For this purpose, the socket edge 16 runs at an angle to the direction of installation R. In the plugged-in state, the plug base 13 and the socket base 15 can lie on top of each other, as shown in FIG. 4.

As can be seen in FIG. 4, the plug contour 12 can surround the insertion chamfer 11 when plugged in. The respective plug connection 9 is inserted into the corresponding socket opening 10 on the side facing away from the socket edge 16.

As can be seen in particular from FIG. 1, in the exemplary embodiments shown the respective cell unit 3 has a housing-like frame 17 which surrounds the battery cells 4 of the cell unit 3. As indicated in FIGS. 1 through 4, in the exemplary embodiments shown, the insertion chamfer 11 and the plug contour 12 are formed by the frame 17 of the associated cell unit 3. This means that the insertion chamfer 11 is formed in the frame 17 of the second cell unit 3, 3b and the plug contour 12 is formed in the frame 17 of the first cell unit 3, 3a. In addition, in the exemplary embodiments shown, the plug base 13 and the socket base 15 are each formed by the frame 17 of the associated cell unit 3.

As indicated in FIG. 5, the battery 1 can have an end stop 18 for the plug 7 and the socket 8 in such a way that further movement of the plug 7 and the socket 8 in relation to each other is blocked when plugged in. FIG. 5 shows a separate state of the plug 7 and the socket 8. In the exemplary embodiment shown in FIG. 5, the end stop 18 is formed on the cell units 3. For this purpose, the cell units 3 have stop surfaces 19 on their sides facing each other along the direction of installation R, which abut against each other with the socket 8 when the plug 7 is plugged in (not shown). As further indicated in FIG. 5, in the exemplary embodiment shown, the stop surface 19 of the first cell unit 3, 3a surrounds the plug 7 and the stop surface 19 of the second cell unit 3, 3b surrounds the socket 8.

As indicated in FIG. 6, the battery 1 can be used in a vehicle 100. The battery 1 can be a traction battery 20 to power the vehicle 100.

1. A battery, in particular a traction battery for a vehicle, comprising:
a housing,
a first cell unit and a second cell unit, which that are arranged in the housing and follow one another in a direction of installation,
wherein the first cell unit and the second cell unit respectively have at least two battery cells which are electrically connected to one another in the respective cell unit,
wherein the first cell unit has on its side facing the second cell unit along the direction of installation a plug with at least one plug connection projecting along the direction of installation,
wherein the second cell unit has a socket on its side facing the first cell unit along the direction of installation, the socket has an associated socket opening for the at least one plug connection,
wherein the at least one plug connection is insertable into the associated socket opening so that the cell units are electrically connected to one another,
wherein the socket has an insertion chamfer along the direction of installation and the plug has a plug contour complementary to the insertion chamfer, such that when the first and second cell units are moved relative to one another in the direction of installation, the insertion chamfer interacts with the plug contour to center the at least one plug connection relative to the associated socket opening.

2. The battery according to claim 1, wherein:
the socket has a socket base with the at least one socket opening, and
the insertion chamfer is disposed on a socket edge of the socket projecting from the socket base.

3. The battery according to claim 1, wherein:
the plug has a plug base, from which the at least one plug connection projects, and
the plug contour is disposed on a plug edge of the plug projecting from the plug base.

4. The battery according to claim 1, wherein the plug contour surrounds the insertion chamfer when plugged in.

5. The battery according to claim 1, wherein the first cell unit has a frame surrounding the at least two battery cells, wherein the frame forms the plug contour.

6. The battery according to claim 1, wherein the second cell unit has a frame surrounding the at least two battery cells, wherein the frame forms the insertion chamfer.

7. The battery according to claim 1, further comprising an end stop for the plug and the socket.

8. The battery according to claim 7, wherein the end stop is formed on at least one of the first and second cell units.

9. The battery according to claim 1, wherein the housing has an extruded profile that is open along the direction of installation and in which the first and second cell units are arranged.

10. A motor vehicle, comprising: a battery, the battery including:
a housing,
a first cell unit and a second cell unit that are arranged in the housing and follow one another in a direction of installation,
the first cell unit and the second cell unit respectively have at least two battery cells which are electrically connected to one another in the respective cell unit,
the first cell unit has on its side facing the second cell unit along the direction of installation a plug with at least one plug connection projecting along the direction of installation,
the second cell unit has a socket on its side facing the first cell unit along the direction of installation, the socket has an associated socket opening for the at least one plug connection,
the at least one plug connection is insertable into the associated socket opening so that the cell units are electrically connected to one another, and
wherein the socket has an insertion chamfer along the direction of installation and the plug has a plug contour complementary to the insertion chamfer, such that when the first and second cell units are moved relative to one another in the direction of installation, the insertion chamfer interacts with the plug contour to center the at least one plug connection relative to the associated socket opening.

11. The motor vehicle according to claim 10, wherein the battery is a traction battery.

12. The motor vehicle according to claim 10, wherein:
the socket has a socket base with the at least one socket opening, and
the insertion chamfer is disposed on a socket edge of the socket projecting from the socket base.

13. The motor vehicle according to claim 12, wherein:
the plug has a plug base, from which the at least one plug connection projects, and
the plug contour is disposed on a plug edge of the plug projecting from the plug base.

14. The motor vehicle according to claim 10, wherein the plug contour surrounds the insertion chamfer when plugged in.

15. The motor vehicle according to claim 10, wherein the first cell unit has a frame surrounding the at least two battery cells, wherein the frame forms the plug contour.

16. The motor vehicle according to claim 10, wherein the second cell unit has a frame surrounding the at least two battery cells, wherein the frame forms the insertion chamfer

17. The motor vehicle according to claim 10, wherein the battery includes an end stop for the plug and the socket.

18. The motor vehicle according to claim 17, wherein the end stop is disposed on a the first cell unit.

19. The motor vehicle according to claim 17, wherein the end stop is disposed on the second cell unit.

20. The motor vehicle according to claim 10, wherein the housing has an extruded profile that is open along the direction of installation and in which the first and second cell units are arranged.
